(19) United States
(12) Patent Application Publication
(10) Pub. No.: US 2014/0216228 A1
(43) Pub. Date: Aug. 7, 2014

(54) TOOL SUPPORT ASSEMBLY

(71) Applicant: Milliken & Company, Spartanburg, SC (US)

(72) Inventors: Bernhard Zeiler, Moore, SC (US); Patrick A. Petri, Greer, SC (US); Dale S. Kitchen, Boiling Springs, SC (US)

(73) Assignee: MILLIKEN & COMPANY, Spartanburg, SC (US)

(21) Appl. No.: 14/153,146

(22) Filed: Jan. 13, 2014

Related U.S. Application Data
(60) Provisional application No. 61/759,481, filed on Feb. 1, 2013.

(51) Int. Cl. B23D 45/00; B23D 47/10; B23D 47/08; B23D 45/02

(52) U.S. Cl. CPC B23D 45/003; B23D 45/021; B23D 47/10; B23D 47/08
USPC 83/483; 83/582

(57) ABSTRACT

A tool support assembly for working on a surface is provided. The tool support assembly includes a track and a carriage movably mounted on the track. A connector link extends between and couples a tool to the carriage. The tool support assembly also includes a biasing mechanism for urging the tool towards the surface.

### FIELD OF THE SUBJECT MATTER

The present subject matter relates generally to mechanisms and assemblies for supporting tools in elevated positions.

### BACKGROUND OF THE SUBJECT MATTER

Overhead construction work is increasingly common, especially in the growing field of infrastructure repair and rehabilitation. Specific overhead tasks can include cutting grooves, grinding surfaces, needle scaling, sand blasting, drilling holes, etc. Generally, such overhead tasks are done manually.

Manually completing such tasks can be difficult and have certain drawbacks. For example, a worker can be required to lift a heavy tool into an overhead position. This can require significant strength to not only support the tool but also control the tool during use. Further, certain overhead tasks require significant time to complete. Thus, the worker can be required to support the tool in the overhead position for extended periods of time. Supporting the tool in the overhead position can also require the worker to assume an un-ergonomic position for extended periods of time.

When a worker is operating a tool while holding it in the overhead position, dust and debris created by operation of the tool can negatively affect the worker's performance, especially while having to support and guide the tool in an overhead position. The tool can also vibrate significantly while operating—further increasing the difficulty and potentially the worker's performance.

Accordingly, an assembly for supporting tools in an overhead position would be useful. In particular, an assembly for supporting tools in an overhead position and guiding motion of the tools in the overhead position would be useful.

### BRIEF DESCRIPTION OF THE SUBJECT MATTER

The present subject matter provides a tool support assembly for working on a surface. The tool support assembly includes a track and a carriage movably mounted on the track. A connector link extends between and couples a tool to the carriage. The tool support assembly also includes a biasing mechanism for urging the tool towards the surface. Additional aspects and advantages of the subject matter will be set forth in part in the following description, or may be apparent from the description, or may be learned through practice of the subject matter.

In a first exemplary embodiment, a tool support assembly for overhead work on a surface is provided. The tool support assembly defines a vertical direction, a longitudinal direction, and a transverse direction. The vertical, longitudinal, and transverse directions are mutually perpendicular. The tool support assembly includes a track that extends along the longitudinal direction. A carriage is mounted to the track such that the carriage is movable along the longitudinal direction on the track. The tool support assembly also includes a tool with a surface engagement feature. A connector link extends between and couples the carriage and the tool together such that the tool is pivotable relative to the carriage and the tool follows the carriage when the carriage moves along the longitudinal direction on the track. A biasing mechanism is mounted to at least one of the carriage and the tool. The biasing mechanism is configured for urging the surface engagement feature of the tool upwardly against the surface.

In additional exemplary embodiments, the tool may include a blade that is rotatable about an axis that is perpendicular to the longitudinal direction. The blade of the tool may have a plurality of cutting teeth, and at least one of the plurality of cutting teeth may be positioned above the surface engagement feature of the tool by a height along the vertical direction. In addition, the biasing mechanism may have a length of travel along the vertical direction. The length of travel of the biasing mechanism may be greater than the height of the at least one of the plurality of cutting teeth.

In other exemplary embodiments, the biasing mechanism may include a spring or an air bladder, and the tool may include a circular saw or a scarifier. Further, the surface engagement feature of the tool may include a pair of rollers spaced apart from each other along the longitudinal direction. Also, the carriage may include a pair of bearing blocks spaced apart from each other along the longitudinal direction. The bearing blocks may be slidably mounted to the track. Optionally, the bearing blocks may be augmented with hard rollers to transmit the vertical load.

In further exemplary embodiments, the connector link may extend between a proximal end portion rotatably mounted to the carriage and a distal end portion rotatably mounted to the tool. The proximal end portion of the connector link may be spaced apart from the distal end portion of the connector link along the longitudinal direction. Further, the proximal end portion of the connector link may be positioned above the distal end portion of the connector link along the vertical direction.

In a second exemplary embodiment, a tool support assembly for overhead work is provided. The tool support assembly defines a vertical direction and longitudinal direction. The longitudinal direction is perpendicular to the vertical direction. The tool support assembly includes a track that extends along the longitudinal direction between a first end portion and a second end portion. A carriage is mounted to the track such that the carriage is movable along the longitudinal direction between the first end portion of the track and the second end portion of the track. A connector link extends between a proximal end portion and a distal end portion. The connector link is mounted to the carriage at the proximal end portion of the connector link. A tool is pivotally mounted to the carriage with the connector link. The connector link is attached to the tool at the distal end portion of the connector link. A biasing mechanism extends between the carriage and the tool. The biasing mechanism is configured for urging the tool upwardly along the vertical direction.

In additional exemplary embodiments, the biasing mechanism may include at least one of a spring and an air bladder, and the tool may include a circular saw or a scarifier.

In other exemplary embodiments, the tool may have a surface engagement feature and a material removal device. The biasing member may urge the tool upwardly along the vertical direction such that the surface engagement feature of the tool is in contact with a surface to be cut by the material removal device of the tool. In addition, the surface engagement feature of the tool may include a pair of rollers spaced apart from each other along the longitudinal direction, and the material removal device of the tool may include a blade that is rotatable about an axis that is perpendicular to the longitudinal direction. Further, a portion of the material removal device of the tool may be positioned above the surface engagement feature of the tool along the vertical direction. The portion of the material removal device may have a height along the vertical direction. Also, the biasing mechanism may have a length of travel along the vertical direction. The length of travel of the biasing mechanism may be greater than the height of the portion of the material removal device.

In further exemplary embodiments, the proximal end portion of the connector link is rotatably mounted to the carriage and the distal end portion of the connector link is rotatably mounted to the tool. In addition, the proximal end portion of the connector link may be positioned above the distal end portion of the connector link along the vertical direction. Also, the distal end portion and the proximal end portion of the connector link may be spaced apart from each other along the longitudinal direction.

These and other features, aspects and advantages of the present subject matter will become better understood with reference to the following description. The accompanying drawings, which are incorporated in and constitute a part of this specification, illustrate embodiments of the subject matter and, together with the description, serve to explain the principles of the subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures.

FIG. 1 provides a perspective view of a tool support assembly according to an exemplary embodiment of the present subject matter.

FIG. 2 provides a side, elevation view of an exemplary carriage and a view of the tool support assembly of FIG. 1.

FIG. 3 provides another side, elevation view of the exemplary carriage and the tool of the tool support assembly of FIG. 2.

FIGS. 4, 5, and 6 provide partial side, elevation views of the exemplary tool support assembly of FIG. 1 with the tool of the tool support assembly shown in various vertical positions.

FIGS. 7, 8, 9, and 10 provide partial side, elevation views of the exemplary tool support assembly of FIG. 1 with the carriage of the tool support assembly shown in various longitudinal positions on a track of the tool support assembly.

FIGS. 11, 12, 13, 14, and 15 provide schematic views of tool support assemblies according to exemplary embodiments of the present subject matter.

### DETAILED DESCRIPTION OF THE SUBJECT MATTER

Reference now will be made in detail to embodiments of the subject matter, one or more examples of which are illustrated in the drawings. Each example is provided by way of explanation of the subject matter, not limitation of the subject matter. In fact, it will be apparent to those skilled in the art that various modifications and variations can be made in the present subject matter without departing from the scope or spirit of the subject matter. For instance, features illustrated or described as part of one embodiment can be used with another embodiment to yield a still further embodiment. Thus, it is intended that the present subject matter covers such modifications and variations.

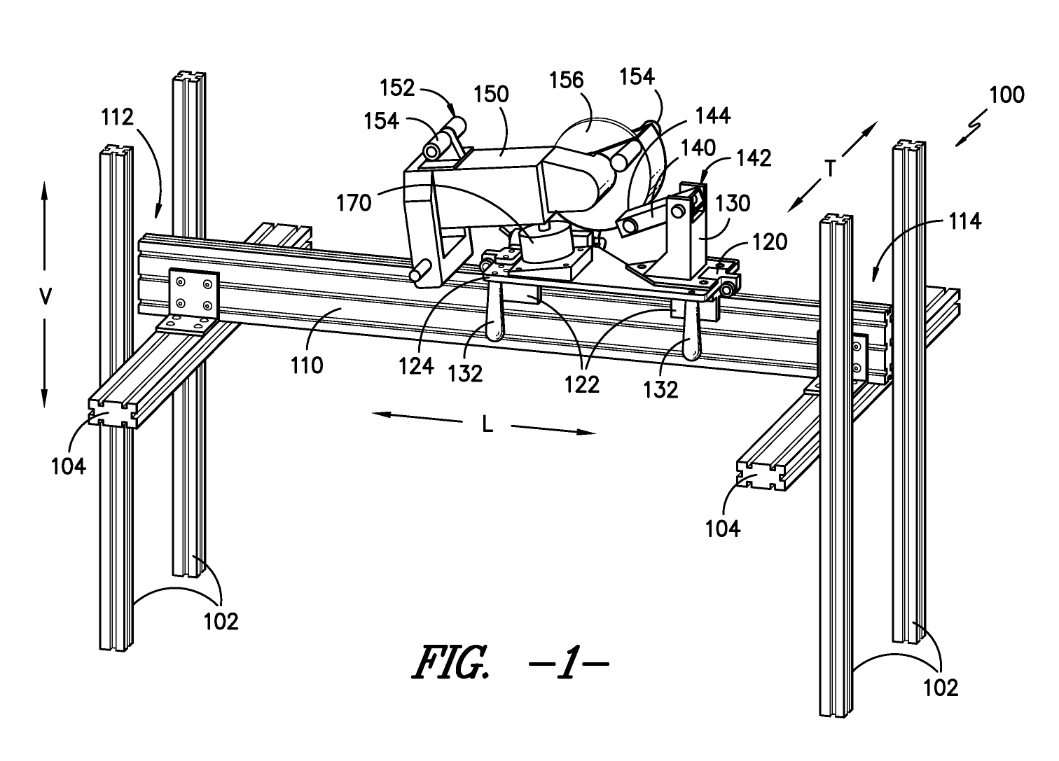

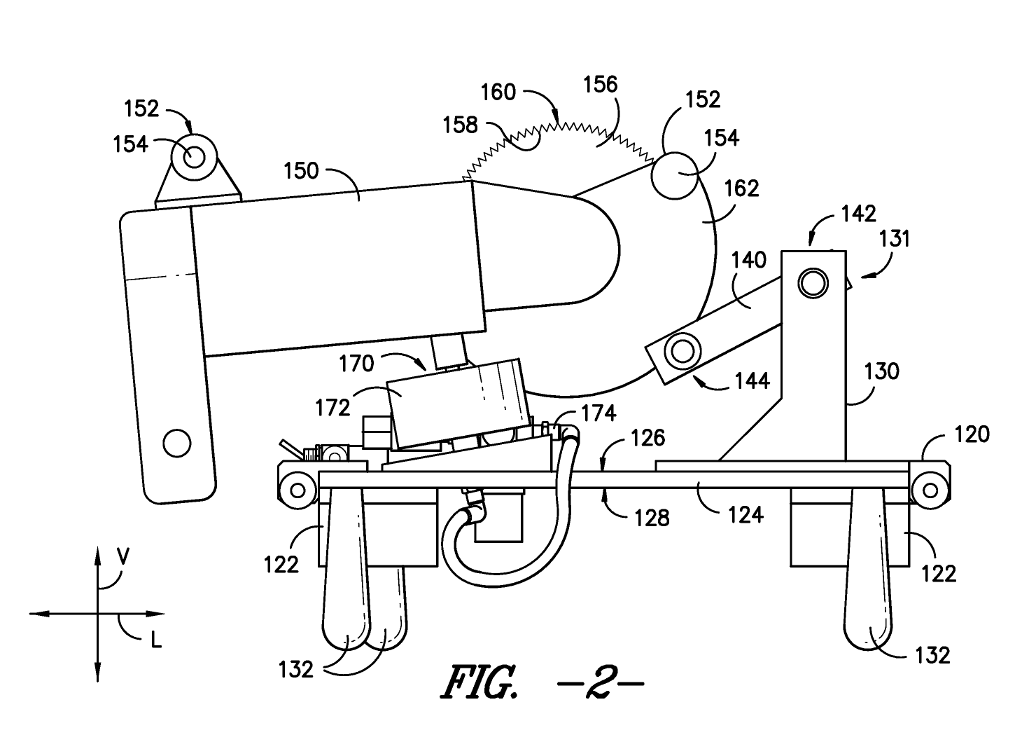

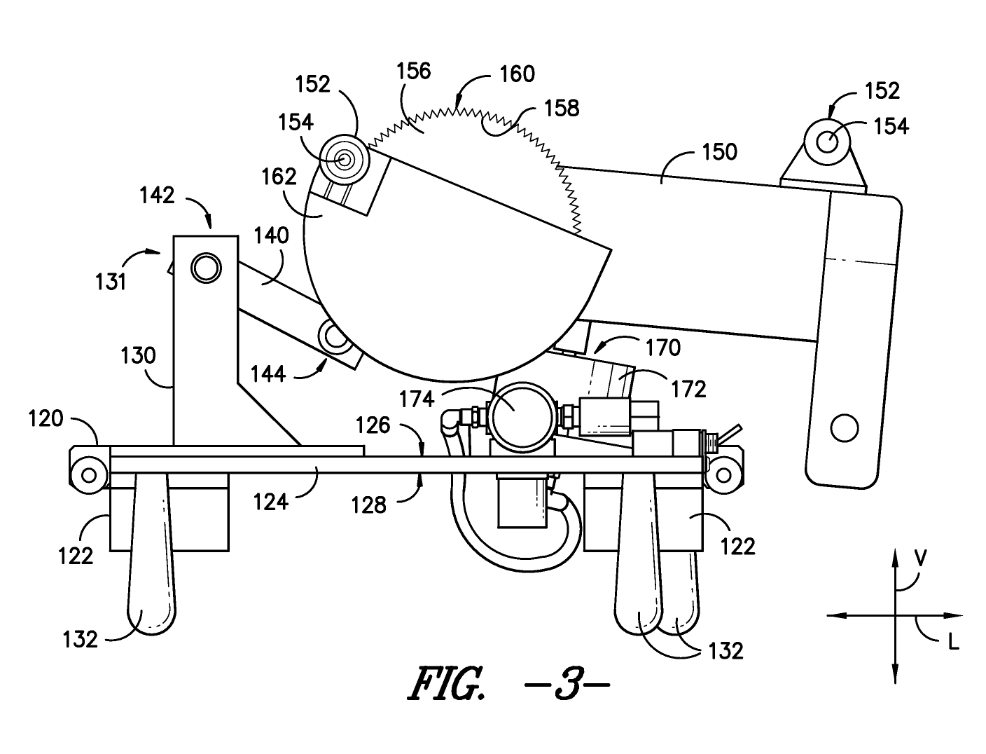

FIG. 1 provides a perspective view of a tool support assembly 100 according to an exemplary embodiment of the present subject matter. FIG. 2 provides a side, elevation view of a carriage 120 and a tool 150 of tool support assembly 100. FIG. 3 provides another side, elevation view of carriage 120 and tool 150 of tool support assembly 100. Tool support assembly 100 is configured assisting work on a surface, such as a ceiling, wall, etc. For example, tool support assembly 100 can support and guide movement of tool 150 during cutting, drilling, grinding, etc. of the associated surface. Tool support assembly 100 defines a vertical direction V, a longitudinal direction L, and a transverse direction T. The vertical, longitudinal, and transverse directions V, L, and T are mutually perpendicular and form an orthogonal direction system. The assembly may be advantaged due to its low weight and easy installation.

Tool support assembly 100 includes a plurality of vertical posts 102. Vertical posts 102 can rest on a lower surface, such as a floor, deck, or the ground, in order to support other components of tool support assembly 100. Vertical posts 102 may also be pressed against the ceiling 106 by an adjustable mechanism such as a shoring jack for added stability. Cross posts 104 extend between and connect or couple pairs of vertical posts 102, e.g., along the transverse direction T. Cross posts 104 are mounted to vertical posts 102 such that vertical positions of cross posts 104 are selectively adjustable. Thus, a user can selectively position cross posts 104 on vertical posts 102, e.g., along the vertical direction V.

Vertical posts 102 and cross posts 104 can be constructed from any suitable material. In the exemplary embodiment shown in FIG. 1, vertical posts 102 and cross posts 104 are constructed from aluminum, such as 80/20 Inc. channels with sliding connections. In alternative exemplary embodiments, vertical posts 102 may be post shores or shoring jacks, vertical and cross posts 102 and 104 may be suitable scaffolding, or vertical and cross posts 102 and 104 may be any other suitable material and construction.

Track 110 is mounted to cross posts 104. Track 110 extends along the longitudinal direction L, e.g., between cross posts 104. In particular, track 110 extends between a first end portion 112 and a second end portion 114 along the longitudinal direction L. First and second end portions 112 and 114 of track 110 are, e.g., linearly, spaced apart from each other along the longitudinal direction L.

First and second end portions 112 and 114 of track 110 can be spaced apart from each other along the longitudinal direction L by any suitable distance. For example, first and second end portions 112 and 114 of track 110 may be spaced apart from each other along the longitudinal direction L, by more than about four feet, more than about six feet, more than about ten feet, or more than about four feet and less than about twenty feet. Track 110 can be constructed from any suitable material. As an example, track 110 may be constructed from aluminum, such as aluminum 80/20 Inc. or Wood rail.

Carriage 120 is, e.g., slidably, mounted to track 110. In particular, carriage 120 is mounted to track 110 such that carriage 120 is movable along the longitudinal direction L on track 110. Carriage 120 may slide on track 110 between about first end portion 112 of track 110 and about second end portion 114 of track 110.

As may be seen in FIGS. 2 and 3, carriage 120 includes a plate 124. Plate 124 has a top surface 126 and a bottom surface 128 positioned opposite each other on plate 124. Thus, top and bottom surfaces 126 and 128 are spaced apart from each other, e.g., along the vertical direction V.

Carriage 120 also includes a pair of bearing blocks 122 for, e.g., slidably, mounting carriage 120 to rail 110 (FIG. 1). Bearing blocks 122 are mounted to plate 124. In particular, bearing blocks 122 are positioned on or at bottom surface 128 of plate 124 and are spaced apart from each other, e.g., along the longitudinal direction L. Bearing blocks 122 can be any suitable mechanism for mounting carriage 120 to track 110. For example, bearing blocks 122 may be 80/20 Inc. sliding bearings. Optionally, a set of high stiffness rollers 121 (not labeled on figures) are mounted to the plate 124 in order to transmit vertical forces with minimal friction. For example, these rollers may be ball bearings rolling on the outer race.

Handles 132 of carriage 120 are also mounted to plate 124, e.g., at bottom surface 128 of plate 124. Handles 132 are configured for assisting a user of tool support assembly 100 with moving carriage 120, e.g., along the longitudinal direction L, as discussed in greater detail below. Carriage 120 further includes a post 130. Post 130 of carriage 120 is mounted to plate 124, e.g., at top surface 126 of plate 124. Post 130 of carriage 120 extends away from top surface 126 of plate 124, e.g., along the vertical direction V. Thus, a distal end portion 131 of post 130 is spaced apart from plate 124, e.g., along the vertical direction V.

Tool support assembly 100 also includes a tool 150, e.g., pivotally, mounted to carriage 120 with a connector link 140. Thus, connector link 140 extends between and couples carriage 120 and tool 150 together. In particular, connector link 140 couples carriage 120 to tool 150 such that tool 150 is pivotable relative to carriage 120, e.g., in a vertical plane that is perpendicular to the transverse direction T. Connector link 140 also connects carriage 120 to tool 150 such that tool 150 follows carriage 120 when carriage 120 moves along the longitudinal direction L on track 110.

Connector link 140 extends between a proximal end portion 142 and a distal end portion 144. Proximal and distal end portions 142 and 144 of connector link 140 are spaced apart from each other, e.g., along the longitudinal direction L. Proximal end portion 142 of connector link 140 is, e.g., rotatably, mounted to carriage 120. In particular, proximal end portion 142 of connector link 140 is rotatably mounted to post 130 of carriage 120 at distal end portion 131 of post 130. Conversely, distal end portion 144 of connector link 140 is, e.g., rotatably, mounted to tool 150.

Tool support assembly 100 further includes a biasing mechanism 170 configured for urging tool 150 upwardly along the vertical direction V. As may be seen in FIGS. 2 and 3, biasing mechanism 170 extends between carriage 120 and tool 150, e.g., in order to permit biasing mechanism 170 to urge carriage 120 and tool 150 apart along the vertical direction V. Biasing mechanism 170 can be mounted to carriage 120, tool 150, both carriage 120 and tool 150, or any other suitable component of tool support assembly 100.

Biasing mechanism 170 can be any suitable mechanism for lifting tool 150 upwardly, e.g., along the vertical direction V. For example, biasing mechanism 170 may be an air bladder 172 as shown in the exemplary embodiment of FIGS. 2 and 3. In alternative exemplary embodiments, biasing mechanism 170 may be a spring, or air cylinder, or hydraulic cylinder, or linear actuator. Air bladder 172 is configured for receipt of compressed air from a regulator 174. For convenience, regulated air from regulator 174 may be routed through a switch valve 175 (not labeled and not connected as shown) before reaching air bladder 172. Thus, air bladder 172 can be filled with air in order to lift tool 150 upwardly.

In the exemplary embodiment shown in FIGS. 2 and 3, tool 150 is a circular saw. However, it should be understood that tool 150 can be any other suitable tool in alternative exemplary embodiments. For example, tool 150 may be a scarifier, a needle scaler, a drill, a grinder (an orbital or a tangential grinder), a sand blaster, a wire brush, a pressure washer, a power-actuated tool, a jack hammer, etc. Thus, the present subject matter is not intended to be limited in any aspect to the particular tool 150 of the exemplary embodiment shown in FIGS. 2 and 3.

For this exemplary embodiment, tool 150 includes a material removal device 156, such as a blade, grinding wheel, wire brush, drill bit, etc. Material removal device 156 is rotatable about an axis, e.g., that is perpendicular to the longitudinal direction L. Tool 150 also has a surface engagement feature 152. Surface engagement feature 152 can assist with properly positioning tool 150, e.g., in the vertical direction V. In particular, biasing mechanism 170 can urge surface engagement feature 152 of tool 150 upwardly against a surface (e.g., a ceiling or wall), and surface engagement feature 152 can ride, roll, or slide along the surface as carriage 120 moves along the longitudinal direction L. In such a manner, surface engagement feature 152 can assist with proper positioning of material removal device 156 and, e.g., hinder excessive cutting by material removal device 156.

Surface engagement feature 152 can be any suitable mechanism for assisting with such positioning. For example, in the exemplary embodiment shown in FIGS. 2 and 3, surface engagement feature 152 includes a pair of rollers 154 that can roll on the surface during operation of tool 150. Rollers 154 are spaced apart from each other, e.g., along the longitudinal direction L. In alternative exemplary embodiments, surface engagement feature 152 may be a plate, deck, or any other suitable mechanism.

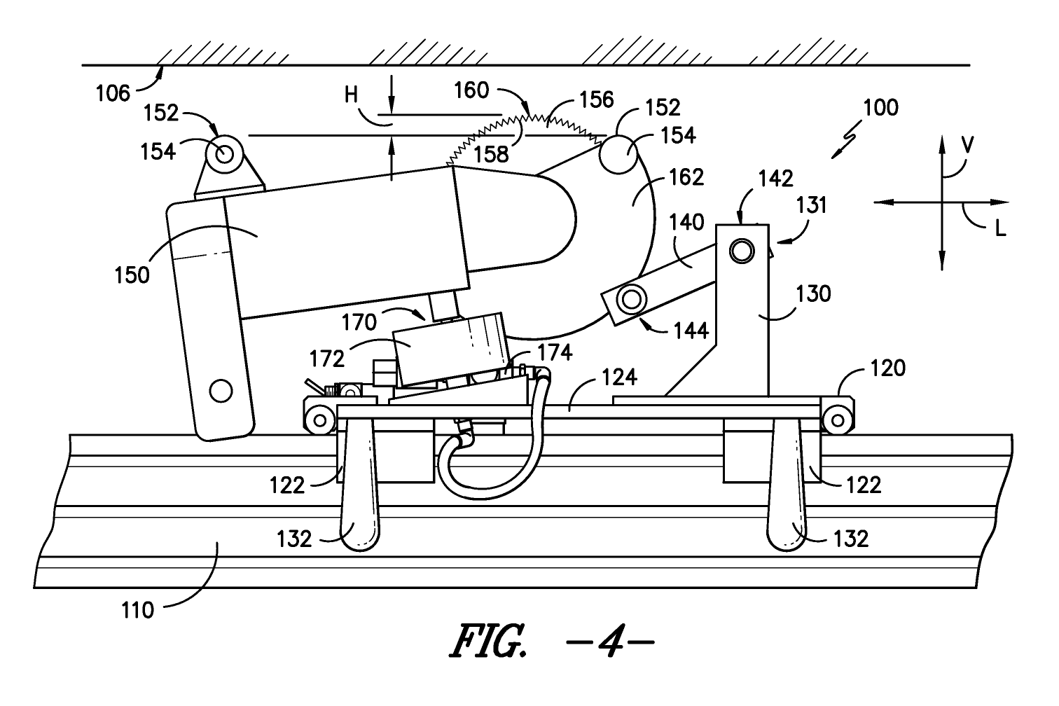

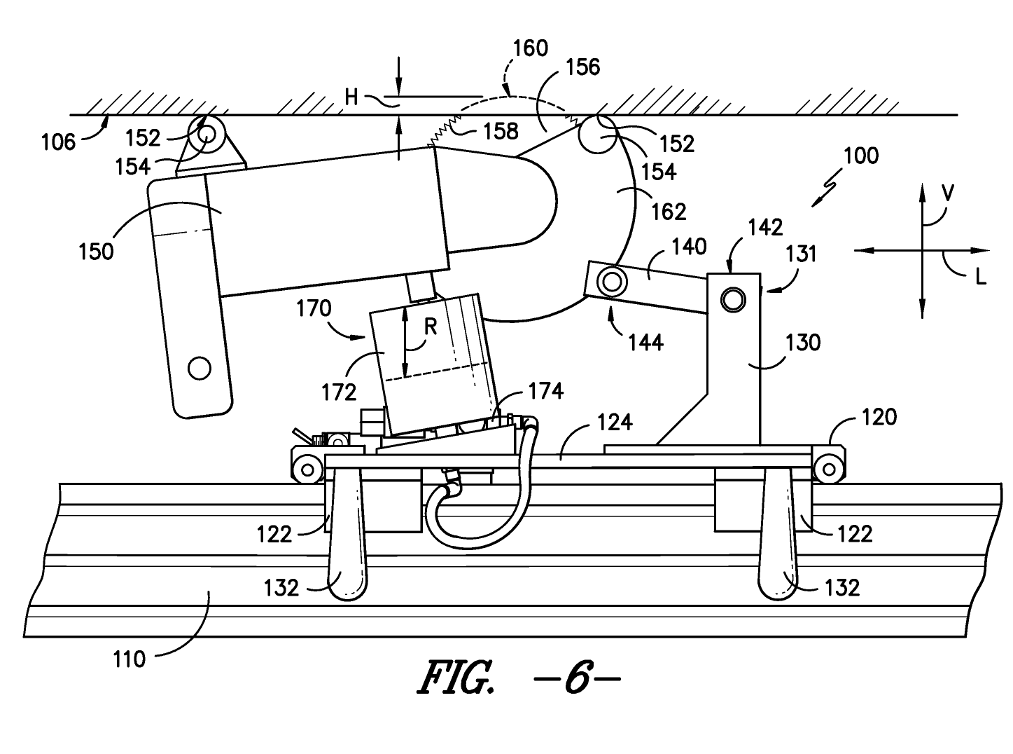

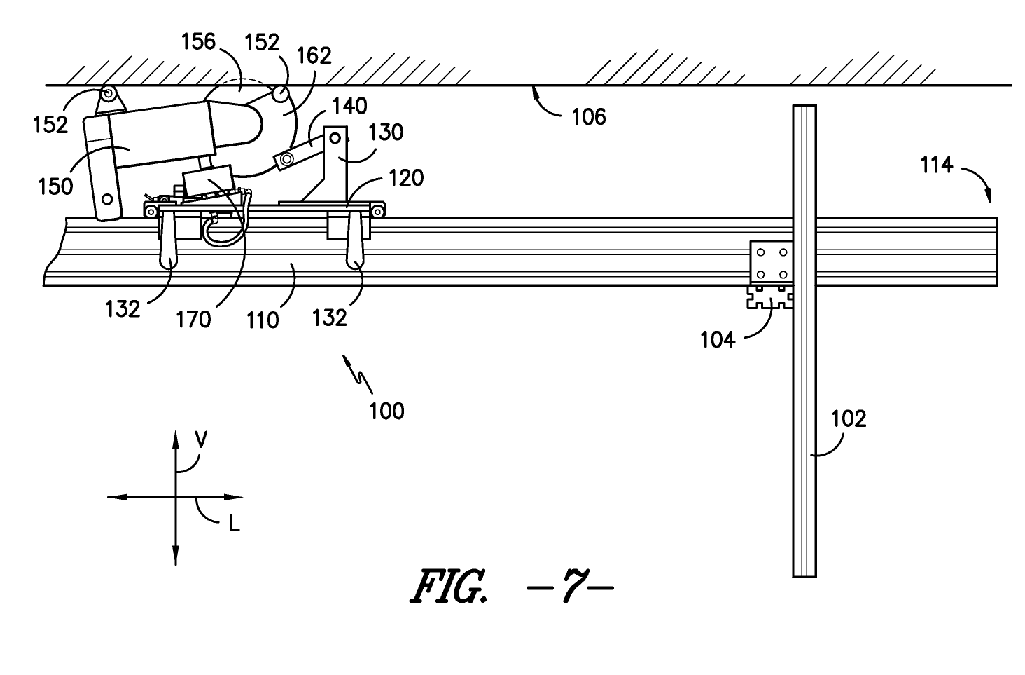

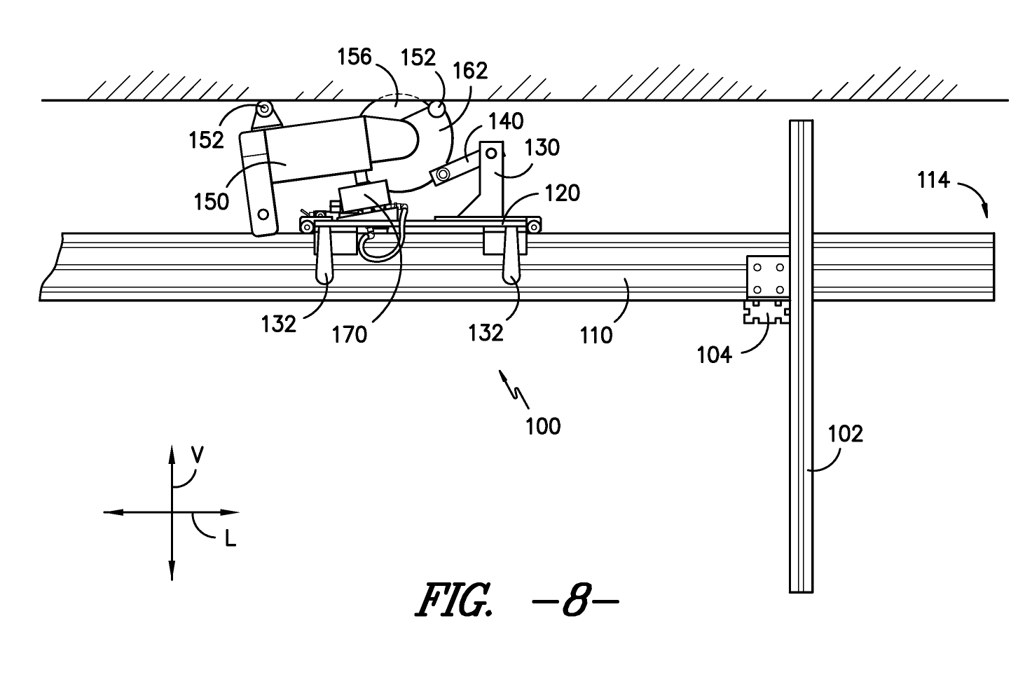

FIGS. 4, 5, and 6 provide partial side, elevation views of tool support assembly 100 with tool 150 of tool support assembly 100 shown in various vertical positions. FIGS. 7, 8, 9, and 10 provide partial side, elevation views of tool support assembly 100 with carriage 120 of tool support assembly 100 shown in various longitudinal positions on track 110 of tool support assembly 100.

As discussed above, tool support assembly 100 is configured assisting overhead work on a surface, such as ceiling 106. As an example, tool support assembly 100 can be utilized to support and guide tool 150 as material removal device 156 of tool 150 cuts a slot or channel in ceiling 106. To cut such slot or channel, vertical and cross posts 102 and 104 are first positioned beneath ceiling 106 and track 110 is supported on and mounted to cross posts 104. Optionally, the vertical posts 102 are pressed firmly against the ceiling 106 by a variable length mechanism such as a shoring jack. Further, cross posts 104 may be adjusted or moved on vertical posts 102 in order to position track 110 at a suitable distance beneath ceiling 106. Carriage 120 is then mounted to track 110 such that carriage 120 can slide or move on track 110 as discussed above.

Tool 150 can require electricity to operate. Similarly, air bladder 172 can require compressed air to operate. Tool 150 can also include a dust collection system 162. Thus, with track 110 and carriage 120 properly positioned, regulator 174 of air bladder 172 can be connected to an air compressor (not shown), dust collection system 162 can be connected to a vacuum (not shown), and tool 150 can be connected to a power supply (not shown), such as a generator or power outlet. With tool support assembly 100 assembled, tool support assembly 100 may be adjusted in order to properly position material removal device 156 of tool 150 for cutting the slot on ceiling 106.

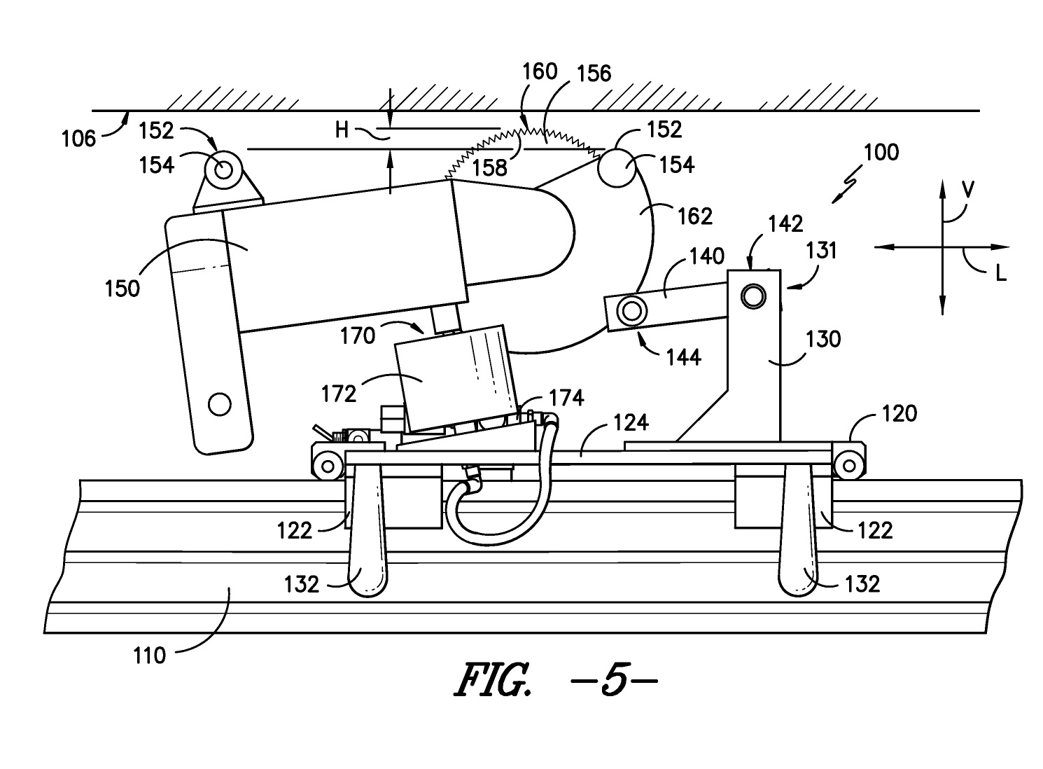

To begin cutting the slot, tool 150 is activated, e.g., such that material removal device 156 is rotating and ready to remove material from ceiling 106. Biasing mechanism 170 is then activated to urge tool 150 upwardly. As may be seen in FIGS. 4, 5, and 6, biasing member 170 can urge tool 150 upwardly along the vertical direction V until surface engagement feature 152 of tool 150 contacts ceiling 106 and material removal device 156 of tool 150 begins to cut the slot in ceiling 106. Biasing member 170 may hold tool 150 in the position shown in FIG. 6 during cutting of the slot in ceiling 106. In such a manner, a depth of the slot in ceiling 106 cut by material removal device 156 of tool 150 can be controlled with surface engagement feature 152 of tool 150.

To cut the slot in ceiling 106, carriage 120 is moved along the longitudinal direction L on track 110 as shown in FIGS. 7-10. In the desired starting position, the biasing element 170 is activated. Due to the offset between biasing element 170 and material removal device 156, distal surface engagement feature 152 will be first to contact ceiling 106. Material removal device 156 then gradually removes material from ceiling 106 until proximal contact element (also 152) touches and the tool 150 is fully engaged. A user of tool support assembly 100 may utilize handles 132 of carriage 120 to push or pull carriage 120 along the longitudinal direction L on track 110. Because tool 150 is coupled to carriage 120 with connector link 140, movement of carriage 120 is transferred to tool 150 such that tool 150 follows carriage 120 along the longitudinal direction L.

With the cutting of the slot in ceiling 106 complete, carriage 120 is positioned as shown in FIG. 10. In one embodiment, no element of the tool support assembly 100, including handles 132, extend below the plane of cross post 104, allowing the tool support assembly 100 to slide past the supports 102 and 104 and even off the end of the track 110. To cut an additional parallel slot in ceiling 106, the tool 150 is disengaged by retracting biasing element 170 and track 110 may be indexed over an appropriate distance along the transverse direction T on cross posts 104. Carriage 120 may be then be repositioned to the location shown in FIG. 7 (but with blade retracted), and the above process can be repeated.

Turning back to FIGS. 4 and 5, certain portions of material removal device 156 of tool 150 are positioned above surface engagement feature 152 of tool 150, e.g., along the vertical direction V. Such portions of material removal device 156 engage and remove material during operation of tool 150 as described above. In certain exemplary embodiments, material removal device 156 can include a plurality of cutting teeth 158 (or diamond particles). During rotation of material removal device 156, cutting teeth 158 can engage and cut material.

Material removal device 156 also includes a peak 160 that corresponds to a vertically highest point of material removal device 156. Peak 160 of material removal device 156 can be spaced apart from surface engagement feature 152 of tool 150, e.g., along the vertical direction V. In particular, peak 160 of material removal device 156 and surface engagement feature 152 of tool 150 can be spaced apart by a height H. Height H can correspond to a depth of cuts made by material removal device 156 during operation of tool 150. In certain exemplary embodiments, at least one of cutting teeth 158 can be positioned at peak 160 and be positioned above surface engagement feature 152 of tool 150 by the height H, e.g., along the vertical direction V.

Turning back to FIG. 4, air bladder 172 of biasing mechanism 170 is deflated such that biasing mechanism 170 is not urging tool 150 upwardly. Conversely, in FIG. 6, air bladder 172 of biasing mechanism 170 is inflated such that biasing mechanism 170 lifts tool 150 upwardly. The shift in biasing mechanism 170 from the position shown in FIG. 4 to the position shown in FIG. 6 corresponds to a length of travel R of biasing mechanism 170, e.g., along the vertical direction V. The length of travel R of biasing mechanism 170 can be greater than the height H of cutting teeth 158.

In one embodiment, as may be seen in FIG. 7, proximal end portion 142 of connector link 140 can be positioned above distal end portion 144 of connector link 140, e.g., along the vertical direction V. Such a configuration may aid in lifting the saw by applying a slight lifting force pushing the saw upward intro the vertical direction. Furthermore, such a configuration can provide enough slop to permit tool 150 to self-position without binding, and, once engaged, tool 150 can be pulled forward with connector link 140 such that tool 150 tends to follow a straight line. In another embodiment, as may be seen in FIG. 6, proximal end portion 142 of connector link 140 can be positioned below distal end portion 144 of connector link 140, e.g., along the vertical direction V which may allow for a shorter connecting link 140 while maintaining the same vertical height R.

As one can see from FIGS. 5 and 6, when the blade is engaged with the ceiling, the saw is raised and moved away from the track. In FIGS. 7-10, there will typically be a gap between the saw and the track (not shown).

In additional exemplary embodiments, track 110 can be constructed form multiple components spliced together to form track 110. In such a manner, track 110 can be constructed with any suitable length along the longitudinal direction L. For example, splicing sufficient components together to form track 110 can permit very long cuts or other operations on a surface, such as ceiling 106. For very long cuts, additionally intermediate supports 102 may be used.

It should be understood that tool support assembly 100 can be used to support tool 150 during cutting surfaces other than ceiling 106. Thus, in other exemplary embodiments, tool support assembly 100 can be configured for supporting tool 150 while tool 150 is used on any suitable vertically or horizontally oriented surface. For example, track 110 may be vertically oriented to cut slots in vertically oriented walls, columns, or sides of beams.

It should also be understood that tool support assembly 100 can be supported on any suitable surface or structure. For example, tool support assembly 100 can rest on a lower surface, such as a floor or deck, as discussed above. In alternative exemplary embodiments, tool support assembly 100 may be mounted to an adjacent structure, or tool support assembly 100 may be attached or mounted to a structure that is being cut by tool 150, e.g., ceiling 106 (or column or wall).

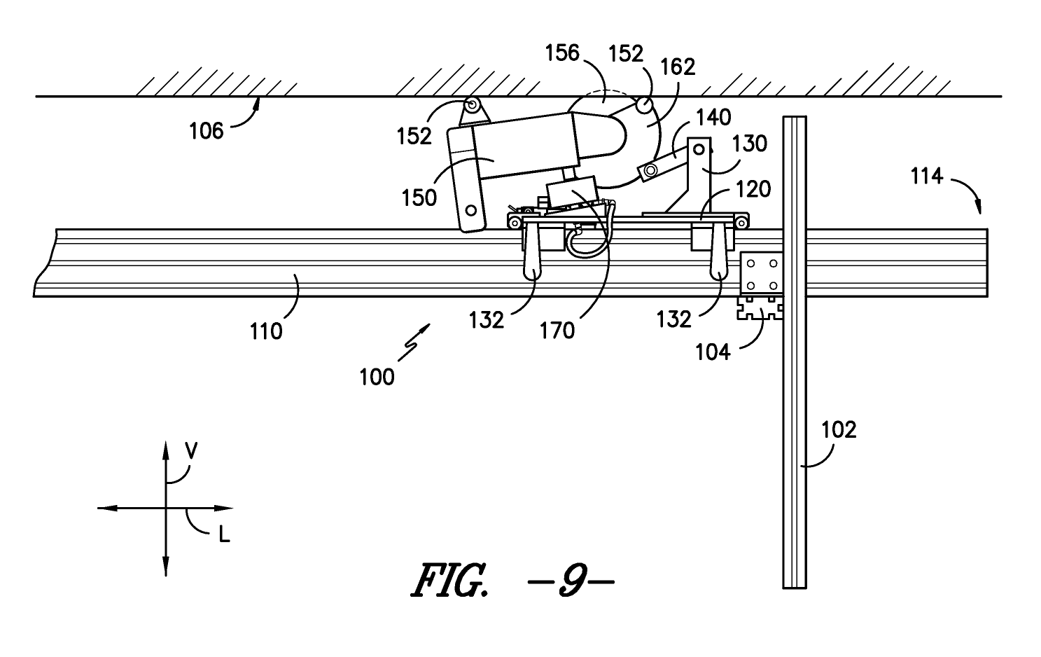

FIGS. 11, 12, 13, 14, and 15 provide schematic views of various tool support assemblies according to exemplary embodiments of the present subject matter. FIG. 11 provides a schematic view of a tool support assembly 1100 with a track 1110 and a carriage 1120 mounted thereto. Carriage 1120 is mounted to track 1110 such that cutting force of a tool 1122 is substantially in line with track 1110, e.g., along the transverse direction T.

In one embodiment, the tool may also be moved in the traverse and the longitudinal directions simultaneously to create a diagonal, sinusoidal, or other non-linear cuts.

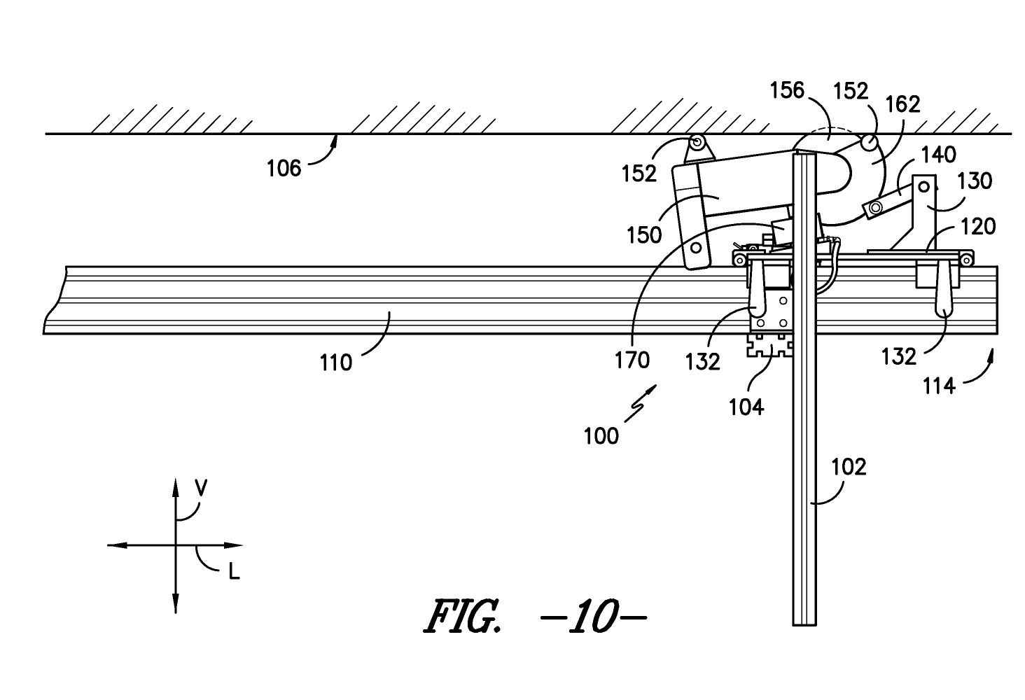

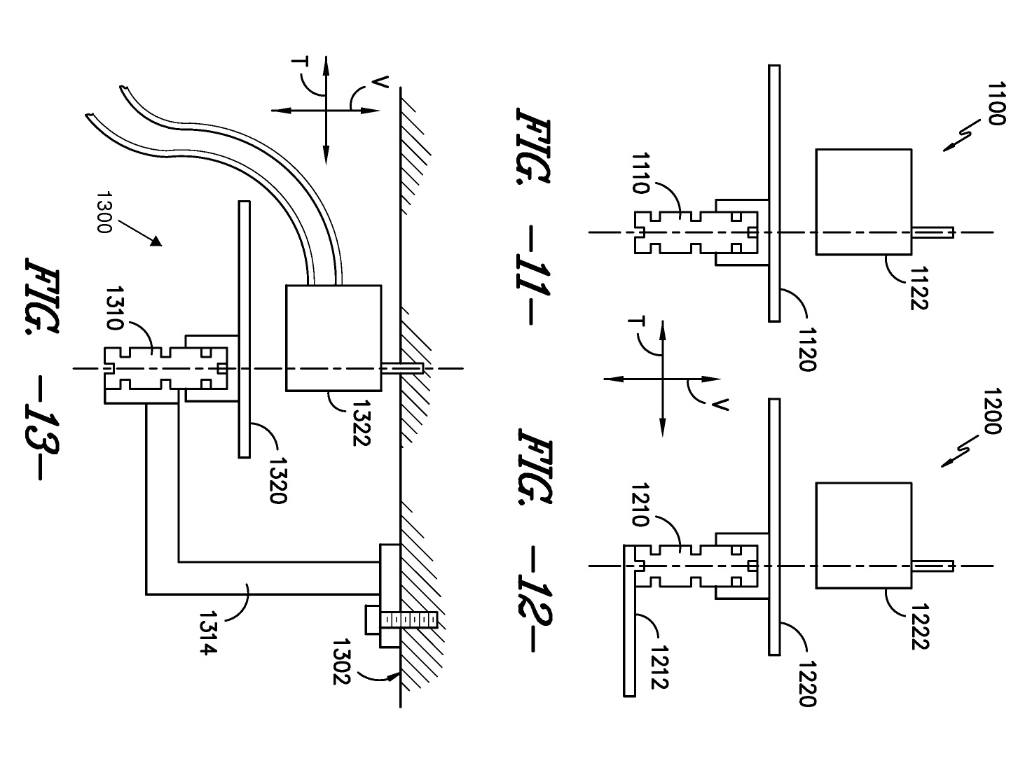

FIG. 12 provides a schematic view of a tool support assembly 1200 with a track 1210 and a carriage 1220 mounted thereto. Carriage 1220 has a tool 1222. Track 1210 is reinforced with a stiffening member 1212, e.g., for improving stability of track 1210 in the transverse direction T. FIG. 13 provides a schematic view of a tool support assembly 1300 with a track 1310 and a carriage 1320 mounted thereto. Track 1310 can be reinforced with a stiffening member, such as stiffening member 1212 (FIG. 12), e.g., for improving stability of track 1310 in the transverse direction T and torsional stiffness along the longitudinal direction L. Track 1310 also includes a bracket 1314, e.g., to limit movement of track 1310 in the vertical direction V and transverse direction T. Bracket 1314 can be bolted to a surface 1302, e.g., such that tool support assembly 1300 would not require vertical or cross posts 102 and 104 of tool support assembly 100 (FIG. 1).

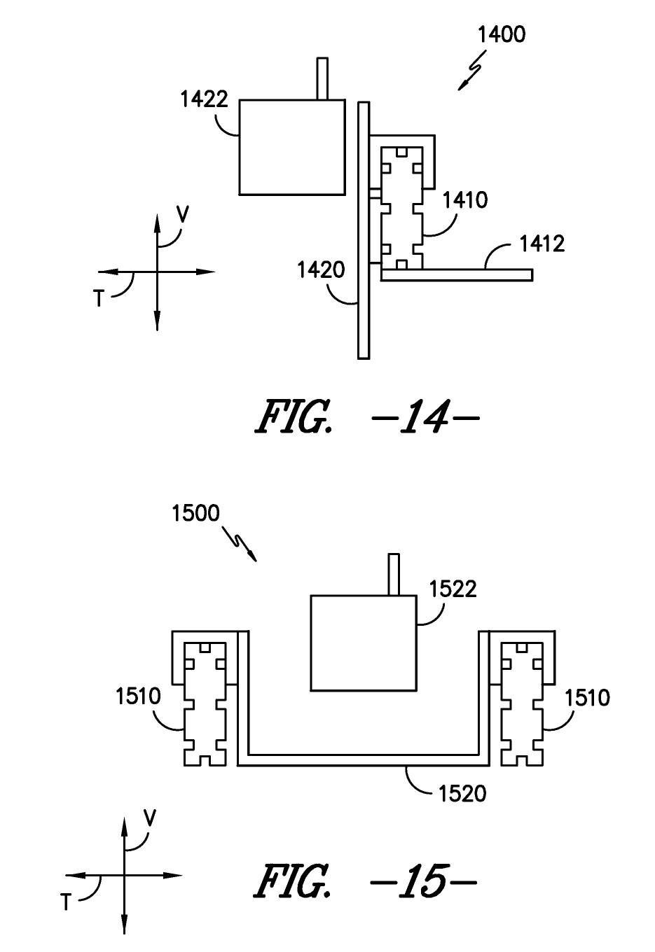

FIG. 14 provides a schematic view of a tool support assembly 1400 with a track 1410 and a carriage 1420 mounted thereto. Track 1410 is reinforced with a stiffening member 1412, e.g., for improving stability of track 1410 in the transverse direction T. Carriage 1420 is mounted to track 1410 such that a tool cutting force of a tool 1422 is offset from track 1410, e.g., along the transverse direction T. Thus, an overall height of tool support assembly 1400 can be reduced relative to tool support assembly 1100 (FIG. 11). The bottom of carriage 1420 may also terminate at the same plane as stiffening member 1412 to minimize overall height.

FIG. 15 provides a schematic view of a tool support assembly 1500 with a pair of tracks 1510 and a carriage 1520 mounted thereto. Tracks 1510 are spaced apart from each other along the transverse direction, e.g., for improving stability of tracks 1510 and carriage 1520 in the transverse direction T. Carriage 1520 is mounted to tracks 1510 such that a tool cutting force of a tool 1522 is offset from tracks 1510, e.g., along the transverse direction T. Thus, an overall height of tool support assembly 1500 can be reduced relative to tool support assembly 1100 (FIG. 11).

This written description uses examples to disclose the presently disclosed subject matter, including the best mode, and also to enable any person skilled in the art to practice the presently disclosed subject matter, including making and using any devices or systems and performing any incorporated methods. While the presently disclosed subject matter has been described in detail with respect to specific embodiments thereof, it will be appreciated that those skilled in the art, upon attaining an understanding of the foregoing may readily adapt the present technology for alterations or additions to, variations of, and/or equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A tool support assembly for overhead work on a surface, the tool support assembly defining a vertical direction, a longitudinal direction, and a transverse direction, the vertical, longitudinal, and transverse directions being mutually perpendicular, the tool support assembly comprising:
a track that extends along the longitudinal direction;
a carriage mounted to said track such that said carriage is movable along the longitudinal direction on said track;
a tool having a surface engagement feature;
a connector link extending between and coupling said carriage and said tool together such that said tool is pivotable relative to said carriage and said tool follows said carriage when said carriage moves along the longitudinal direction on said track; and
a biasing mechanism mounted to at least one of said carriage and said tool, said biasing mechanism urging the surface engagement feature of said tool upwardly against the surface.

2. The tool support assembly of claim 1, wherein said tool comprises a blade that is rotatable about an axis that is perpendicular to the longitudinal direction, the blade of said tool having a plurality of cutting teeth, at least one of the plurality of cutting teeth being positioned above the surface engagement feature of said tool by a height along the vertical direction.

3. The tool support assembly of claim 2, wherein said biasing element has a length of travel along the vertical direction, the length of travel of said biasing element being greater than the height of the at least one of the plurality of cutting teeth.

4. The tool support assembly of claim 3, wherein said biasing mechanism is selected from the group consisting of a spring, an air cylinder, an electrical actuator, and an air bladder.

5. The tool support assembly of claim 1, wherein said tool comprises a circular saw or a scarifier.

6. The tool support assembly of claim 1, wherein said carriage comprises a pair of bearing blocks spaced apart from each other along the longitudinal direction, said bearing blocks slidably mounted to said track.

7. The tool support assembly of claim 6, wherein said bearing blocks are augmented by rolling element bearings for transmitting vertical loads.

8. The tool support assembly of claim 1, wherein the surface engagement feature of said tool comprises a pair of rollers spaced apart from each other along the longitudinal direction.

9. The tool support assembly of claim 1, wherein said connector link extends between a proximal end portion rotatably mounted to said carriage and a distal end portion rotatably mounted to said tool, the proximal end portion of said connector link spaced apart from the distal end portion of said connector link along the longitudinal direction.

10. The tool support assembly of claim 9, wherein the proximal end portion of said connector link is positioned above the distal end portion of said connector link along the vertical direction.

11. The tool support assembly of claim 1, wherein the tool is doubly pivotable relative to said carriage.

12. A tool support assembly for overhead work, the tool support assembly defining a vertical direction and longitudinal direction, the longitudinal direction being perpendicular to the vertical direction, the tool support assembly comprising:
a track that extends along the longitudinal direction between a first end portion and a second end portion;
a carriage mounted to said track such that said carriage is movable along the longitudinal direction between the first end portion of said track and the second end portion of said track;
a connector link extending between a proximal end portion and a distal end portion, said connector link mounted to said carriage at the proximal end portion of said connector link;
a tool pivotably mounted to said carriage with said connector link, said connector link attached to said tool at the distal end portion of said connector link; and
a biasing mechanism extending between said carriage and said tool, said biasing mechanism urging said tool upwardly along the vertical direction.

13. The tool support assembly of claim 12, wherein said biasing mechanism comprises at least one of a spring and an air bladder.

14. The tool support assembly of claim 12, wherein said tool comprises a circular saw or a scarifier.

15. The tool support assembly of claim 12, wherein the proximal end portion of said connector link is rotatably mounted to said carriage and the distal end portion of said connector link is rotatably mounted to said tool.

16. The tool support assembly of claim 12, wherein said tool has a surface engagement feature and a material cutting device, said biasing member urging said tool upwardly along the vertical direction such that the surface engagement feature of said tool is in contact with a surface to be cut by the material cutting device of said tool.

17. The tool support assembly of claim 16, wherein the surface engagement feature of said tool comprises a pair of rollers spaced apart from each other along the longitudinal direction.

18. The tool support assembly of claim 16, wherein the material cutting device of said tool comprises a blade that is rotatable about an axis that is perpendicular to the longitudinal direction.

19. The tool support assembly of claim 16, wherein a portion of the material cutting device of said tool is positioned above the surface engagement feature of said tool along the vertical direction, the portion of the material cutting device having a height along the vertical direction.

20. The tool support assembly of claim 19, wherein said biasing element has a length of travel along the vertical direction, the length of travel of said biasing element being greater than the height of the portion of the material cutting device.

21. The tool support assembly of claim 12, wherein the proximal end portion of said connector link is positioned above the distal end portion of said connector link along the vertical direction.

22. The tool support assembly of claim 12, wherein the distal end portion and the proximal end portion of said connector link are spaced apart from each other along the longitudinal direction.
